(19) United States
(12) Patent Application Publication
(10) Pub. No.: US 2005/0057160 A1
(43) Pub. Date: Mar. 17, 2005

(54) Plasma lamp

(75) Inventors: Gi-young Kim, Chungcheongbuk-do (KR); Deuk-seok Chung, Gyeonggi-do (KR); Won-seok Kim, Gyeonggi-do (KR); Young-mo Kim, Gyeonggi-do (KR); Kyung-min Chung, Gyeonggi-do (KR); Seung-hyun Son, Gyeonggi-do (KR); Hyoung-bin Park, Gyeonggi-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Gyeonggi-do (KR)

(21) Appl. No.: 10/902,843

(22) Filed: Aug. 2, 2004

(30) Foreign Application Priority Data
Aug. 2, 2003 (KR) 2003-53624

(51) Int. Cl. H01K 1/62

(52) U.S. Cl. 315/59; 315/73

(57) ABSTRACT

A plasma lamp includes a container filled with a discharge gas, a main discharge electrode unit located in the container and including a first electrode and a second electrode, which define a main discharge region of a first gap and generate a main discharge, and a preliminary discharge electrode unit having a high resistance unit and arranged on at least one of the first electrode and the second electrode, and located adjacent to the main discharge region to define a preliminary discharge region of a second gap, which is smaller than the first gap. The preliminary discharge electrode unit of the provided plasma lamp induces a preliminary discharge for a short time at a low voltage. A main discharge occurs conveniently due to charged particles generated by the preliminary discharge.

### BACKGROUND OF THE INVENTION

This application claims the priority of Korean Patent Application No. 2003-53624, filed on Aug. 2, 2003, in the Korean Intellectual Property Office, which is incorporated herein in its entirety by reference.

1. Field of the Invention

The present invention relates to a plasma lamp, and more particularly, to a plasma lamp having a low discharge voltage and a high light emitting efficiency.

2. Description of the Related Art

Lamps developed as back-lights of liquid crystal displays (LCDs) are divided into a surface discharge type and a facing surfaces discharge type. Such a lamp is disclosed in US Patent application publication No. 2003/0098643 A1.

Such a plasma lamp includes one or more unit discharge regions having two electrodes, which are arranged in a row. The electrodes are arranged while having a predetermined discharge gap in order to discharge uniformly. Here, discharges between the electrodes occur by AC or DC pulses.

FIGS. 1 through 3 are sectional views illustrating a conventional lamp disclosed in US Patent application publication No. 2003/0098643 A1.

Referring to FIG. 1, a conventional surface discharge type lamp has an upper plate 1 and a lower plate 2, which are separated by walls 7, and a discharge region, which is formed by the upper plate 1 and the lower plate 2 and filled with a discharge gas. Discharge electrodes are formed at both sides of the inner surface of the lower plate 2, and the discharge electrodes 3 and 4 are covered by dielectric layers 5. In addition, fluorescent layers 6 are formed on the inner surfaces of the upper plate 1 and the lower plate 2.

Referring to FIG. 2, an upper plate 1a and a lower plate 2a are spaced by walls 7a, and a discharge region is formed between the upper plate 1a and the lower plate 2a. Discharge electrodes 3a and 4a are formed on the inner surfaces of the upper plate 1a and the lower plate 2a to face each other, and florescent layers 6a are formed on the discharge electrodes 3a and 4a.

Referring to FIG. 3, electrodes 3b and 4b are formed on the inner surfaces of walls 7b that face each other. The electrodes 3b and 4b are protected by dielectric layers 5b. An upper plate 1b and a lower plate 2b are separated by the walls 7b to provide a discharge region, which induces discharge between the electrodes 3b and 4b. Fluorescent layers 6b are formed on the inner surfaces of the upper plate 1b and the lower plate 2b.

Such conventional lamps should improve a discharge efficiency while reducing a driving voltage. Generally, a discharge gas having an excellent discharge efficiency, for example, Xe is used and a discharge gap is sufficiently increased in order to improve the discharge efficiency. However, the increase in the discharge gap causes an undesirable increase in a breakdown voltage.

### SUMMARY OF THE INVENTION

The present invention provides a plasma lamp having a low driving voltage.

The present invention also provides a plasma lamp having a low driving voltage and an excellent discharge efficiency.

According to an aspect of the present invention, there is provided a plasma lamp comprising a container filled with a discharge gas, a main discharge electrode unit including a first electrode and a second electrode, which are located in the container to face each other and define a main discharge region of a first gap that generates a main discharge, and a preliminary discharge electrode unit having a high resistance unit and arranged on at least one of the first electrode and the second electrode, and located adjacent to the main discharge region to define a preliminary discharge region of a second gap, which is smaller than the first gap.

According to another aspect of the present invention, there is provided a plasma lamp comprising a container filled with a discharge gas, a main discharge electrode unit including a first electrode and a second electrode, which are located in the container to face each other and define a main discharge region of a first gap that generates a main discharge, a preliminary discharge electrode unit having a high resistance unit and arranged on at least one of the first electrode and the second electrode, and located adjacent to the main discharge region to define a preliminary discharge region of a second gap, which is smaller than the first gap, and a field emission unit arranged at the end portion of the preliminary discharge electrode unit.

### BRIEF DESCRIPTION OF THE DRAWINGS

The above aspects and advantages of the present invention will become more apparent by describing in detail preferred embodiments thereof with reference to the attached drawings in which:

FIG. 1 is a sectional view illustrating a conventional surface discharge type lamp;

FIG. 2 is a sectional view illustrating a conventional facing surfaces discharge type lamp of upper and lower plates;

FIG. 3 is a sectional view illustrating a conventional facing surfaces discharge type lamp of sidewalls;

FIG. 4A is a perspective view illustrating a plasma lamp according to a first embodiment of the present invention;

FIG. 4B is a plan view illustrating a plasma lamp according to the first embodiment of the present invention;

FIG. 5 is an enlarged view illustrating a preliminary discharge unit of a plasma lamp according to the present invention;

FIG. 6 is a perspective view illustrating a plasma lamp according to a second embodiment of the present invention;

FIG. 7 is a plan view illustrating a plasma lamp according to a third embodiment of the present invention;

FIG. 8 is a sectional view illustrating a plasma lamp according to a fourth embodiment of the present invention;

FIG. 9 is a sectional view illustrating a plasma lamp according to a fifth embodiment of the present invention;

FIG. 10A is a plan view illustrating a plasma lamp according to a sixth embodiment of the present invention;

FIG. 10B is an enlarged view of FIG. 10A;

FIG. 11 is a plan view illustrating a plasma lamp according to a seventh embodiment of the present invention;

FIG. 12 is a sectional view illustrating a plasma lamp according to an eighth embodiment of the present invention; and

FIG. 13 is a sectional view illustrating a plasma lamp according to a ninth embodiment of the present invention.

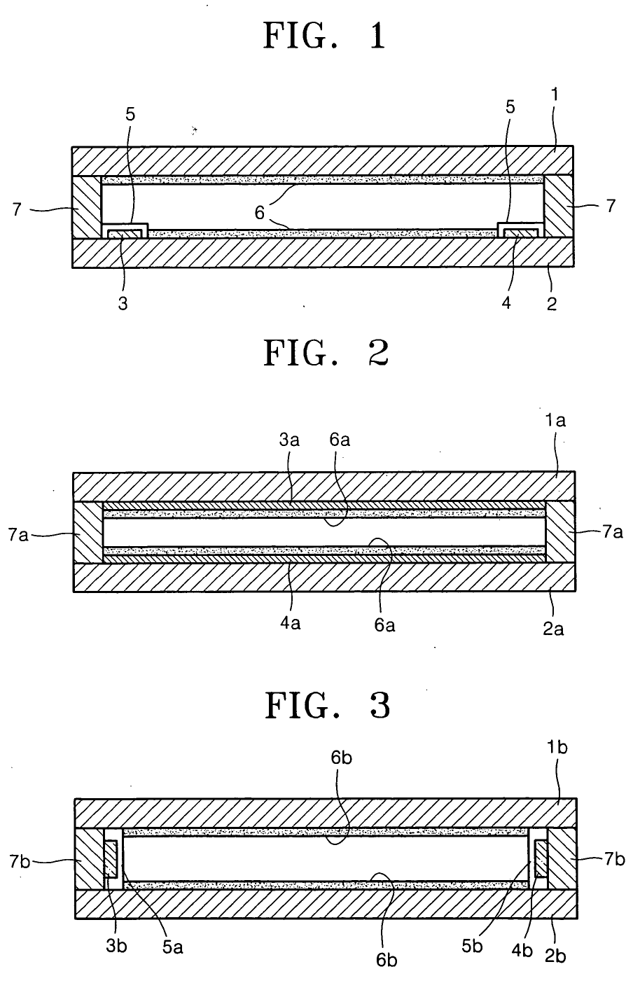

### DETAILED DESCRIPTION OF THE INVENTION

The present invention will now be described more fully with reference to the accompanying drawings, in which exemplary embodiments of the invention are shown.

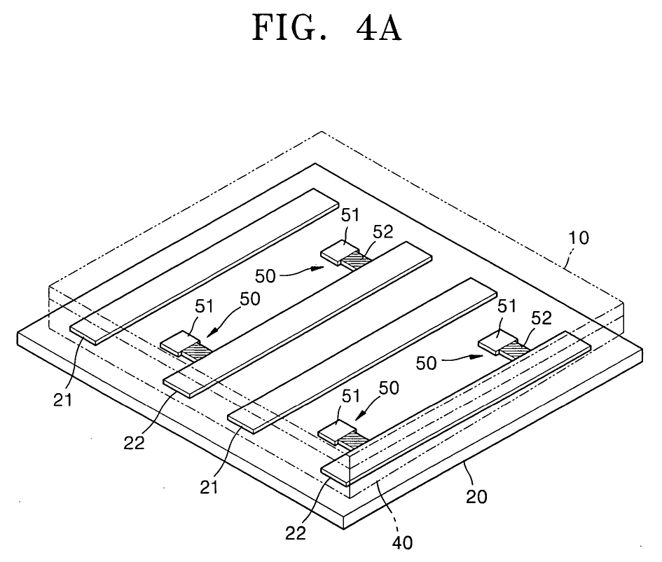

FIGS. 4A and 4B are views illustrating a plasma lamp according to a first embodiment of the present invention. Referring to FIGS. 4A and 4B, an upper plate 10 and a lower plate 20 are separated by a predetermined distance, and a discharge gas is filled in a space formed by the upper plate 10 and the lower plate 20. Two couples of first electrodes 21 and second electrodes 22 are arranged on the lower plate 20 in a row.

The upper plate 10 and the lower plate 20, which are separated by walls 40, form a discharge space 30 filled with a discharge gas. Fluorescent layers (not shown) are formed on the inner surfaces or any surfaces of the upper plate 10 and the lower plate 20.

Preliminary discharge units 50, which are a characteristic of the present invention, are formed on the second electrodes 22. Two preliminary discharge units 50 are formed on the second electrodes 22 in FIGS. 4A and 4B. The preliminary discharge unit 50 includes a preliminary discharge terminal 51, which maintains a narrower gap than a main discharge gap between the first electrode 21 and the second electrode 22, and a high resistance unit 52, which is arranged between the preliminary discharge terminal 51 and the second electrode 22.

The high resistance unit 52 and the preliminary discharge terminal 51 are integrally formed, and the high resistance unit 52 may act as a preliminary discharge terminal without using the preliminary discharge terminal 51.

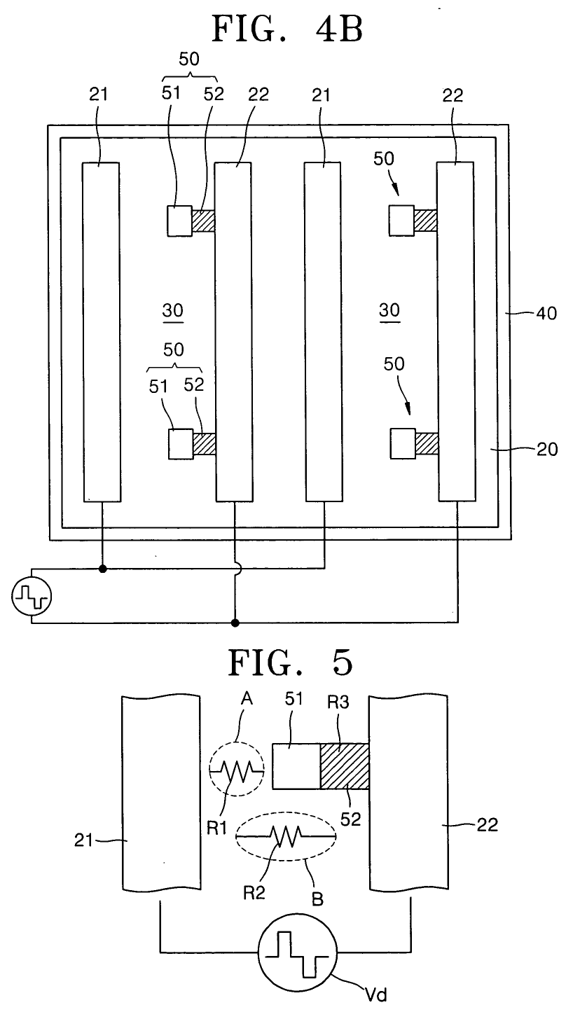

A discharge mechanism of a lamp according to the present invention will now be described with reference to FIG. 5. A preliminary discharge region (A) by a preliminary discharge unit has a narrower gap than a main discharge region (B) between a first electrode 21 and a second electrode 22. The difference between the gaps is in a direct proportion to the ratio of space resistances R1 and R2 in each region A and B. In other words, the space resistance R1 of the preliminary discharge region A having a narrow gap is proportionally lower than the space resistance R2 of the main discharge region B having a wide gap. The space resistances R1 and R2 are very high, resulting in requiring a high discharge voltage Vd for inducing the ionization of the gas in order to occur discharge between the space resistances R1 and R2. Here, the discharge voltage Vd is determined to induce the breakage of an insulating barrier in the preliminary discharge region A. Accordingly, the discharge voltage Vd is determined to be smaller than an insulating breakage voltage between the first electrode 21 and the second electrode 22. The pulse discharge voltage Vd is applied to the first electrode 21 and the second electrode 22, and the most of the discharge voltage Vd is applied to the preliminary discharge region A1 and the main discharge region A2. Here, the insulating breakage occurs in the preliminary discharge region A1 having a relatively low space voltage, resulting in the induction of discharge. The discharge in the preliminary discharge region A1 causes an electric short in the preliminary discharge region A1, so that a preliminary discharge is stopped in a short time. The electric short in the preliminary discharge region A1 by the discharge causes the transfer of currents in the preliminary discharge region A1, which means that the space resistance R1 in the preliminary discharge region A1 is significantly lowered compared to a resistance value R3 of a high resistance unit 52. Due to the decrease in the space resistance R1, a partial pressure in the preliminary discharge region A having a lower resistance than the high resistance unit 52 becomes lower than a discharge maintaining voltage. As a result, the discharge in the preliminary discharge region A generates the electric short and stops the discharge. Regardless of the start and the stop of the discharge in the preliminary discharge region A, a large amount of space discharged particles generated by the preliminary discharge present in and around the preliminary discharge region A1. The space discharged particles stimulate an inner discharge gas, which may start a main discharge under the driving voltage Vd. The main discharge occurs between the first electrode 21 and the second electrode 22, which are in an electrically nonresistant state. Since the space resistance R2 is higher than the first electrode 21 and the second electrode 22 during the main discharge, the driving voltage Vd is applied to the main discharge region B, so that the main discharge is continued. The main discharge is maintained for the amount of time corresponding to the pulse width of the pulse driving voltage.

In the present invention, the narrow preliminary discharge unit is provided to reduce a discharge start voltage between the first electrode and the second electrode, and the high resistance unit for inducing the reduction or the prevention of the partial pressure in the preliminary discharge unit is provided to voluntarily stop the discharge in the preliminary discharge unit.

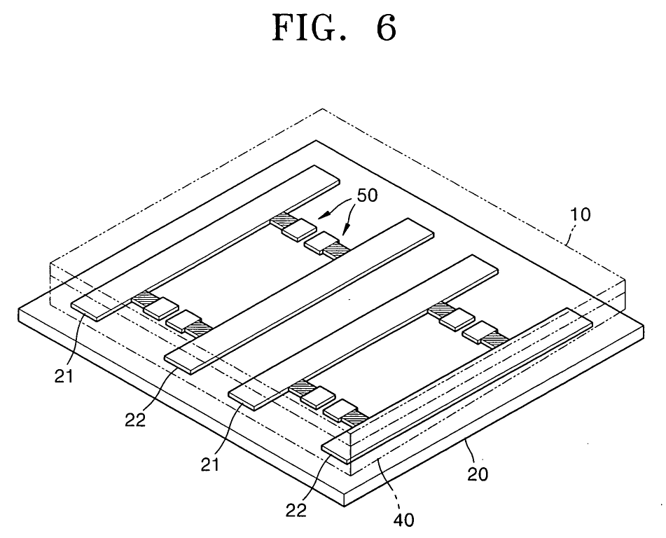

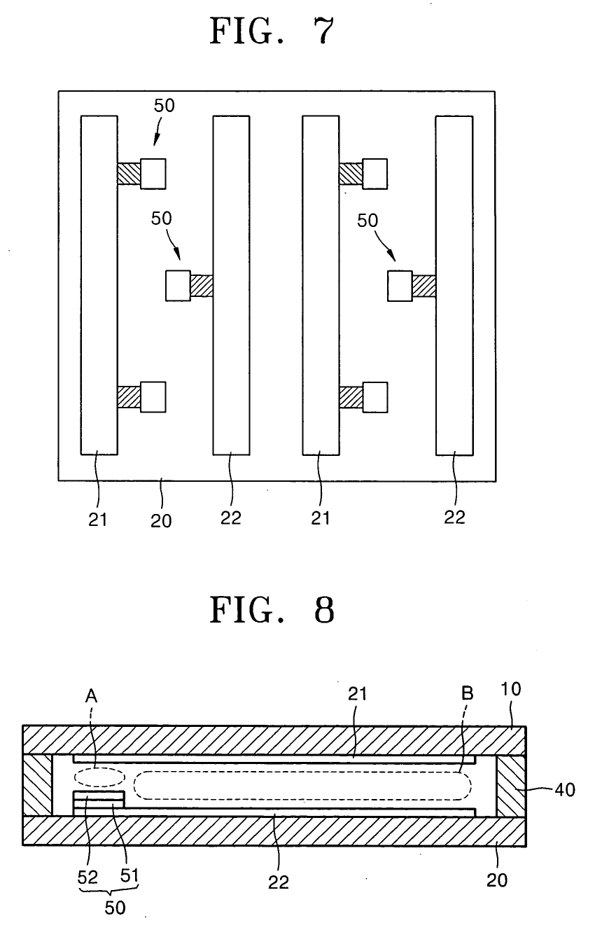

The arrangement of electrodes may be varied. For example, preliminary discharge units 50 are arranged on first electrodes 21 and second electrodes 22 as shown in FIG. 6. A lamp having such a structure is suitable for an AC pulse type. The preliminary discharge units 50 of the electrodes 21 and 22 face each other in FIG. 6; however, preliminary discharge units 50 miss each other as shown in FIG. 7.

The lamps in a surface discharge type shown in FIGS. 5 through 7 may be changed into a facing surfaces discharge type.

Referring to FIG. 8, walls 40 are arranged between a front plate 10 and a rear plate 20, and a first electrode 21 and a second electrode 22 are formed on inner surfaces of the front plate 10 and the rear plate 20. A high resistance unit 52 having a predetermined height is formed at one side of the second electrode 22 on the rear plate 20, and a preliminary discharge terminal 51 is formed on the high resistance unit 52. Accordingly, the high resistance unit 52 and the preliminary discharge unit 51 formed thereon define a preliminary discharge region A corresponding to the first electrode 21, which is formed above the preliminary discharge terminal 51, and the other region between the first electrode 21 and the second electrode 22 is defined as a main discharge region B.

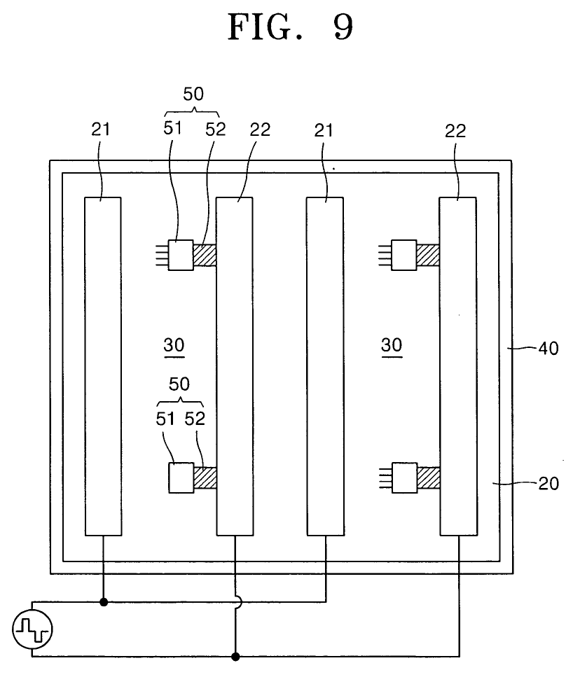

FIG. 9 is a sectional view illustrating an AC pulse type lamp. Referring to FIG. 9, a front plate 10 and a rear plate 20 are arranged while interposing walls 40, and a first electrode 21 and a second electrode 22 are formed on inner surfaces of the front plate 10 and the rear plate 20. Preliminary discharge units 50 having a predetermined height are formed at the both sides of the first electrode 21 and the second electrode 22 to face each other. Dotted portions in FIG. 9 denote the preliminary discharge units 50, which may be removed, and it is known that the design may be varied.

The lamps shown in FIGS. 4 through 7 have a plurality of couples of first electrodes and second electrodes; however, only one couple of first electrode and second electrode may be formed on one substrate, or three or more couples of first electrodes and second electrodes may be formed on one substrate. Here, the number and the arrangement of the electrode couples do not limit the scope of the present invention.

In the lamps according to the first through fifth embodiments of the present invention, the first electrodes and the second electrodes are exposed to a discharge gas; however, a dielectric layer may be formed on the first and the second electrodes in an AC type lamp while coating a material for protecting the electrodes on the first and the second electrodes. Such conventional elements can be applied to the lamps according to the present invention while not limiting the scope of the present invention.

The lamps shown in FIGS. 4 through 7 induce a preliminary discharge at a relatively low voltage and use space charges, which are generated by the preliminary discharge, in a main discharge. The lamps according to the first through fifth embodiments of the present invention may generate more effective plasma discharges by applying a field emission source, which will now be described.

A field emission occurs in a preliminary discharge region when a preliminary discharge takes place. Thus, a field emission source is partially formed in a preliminary discharge unit or a corresponding electrode at a location opposite to the preliminary discharge unit in the preliminary discharge region. The field emission occurs by using a conventional field emission material, such as a micro-tip or a carbon nanotube. Accordingly, the field emission source is formed of such a material. The material for the field emission source is selected according to the design of a lamp, particularly, the shape of electrodes and the preliminary discharge unit.

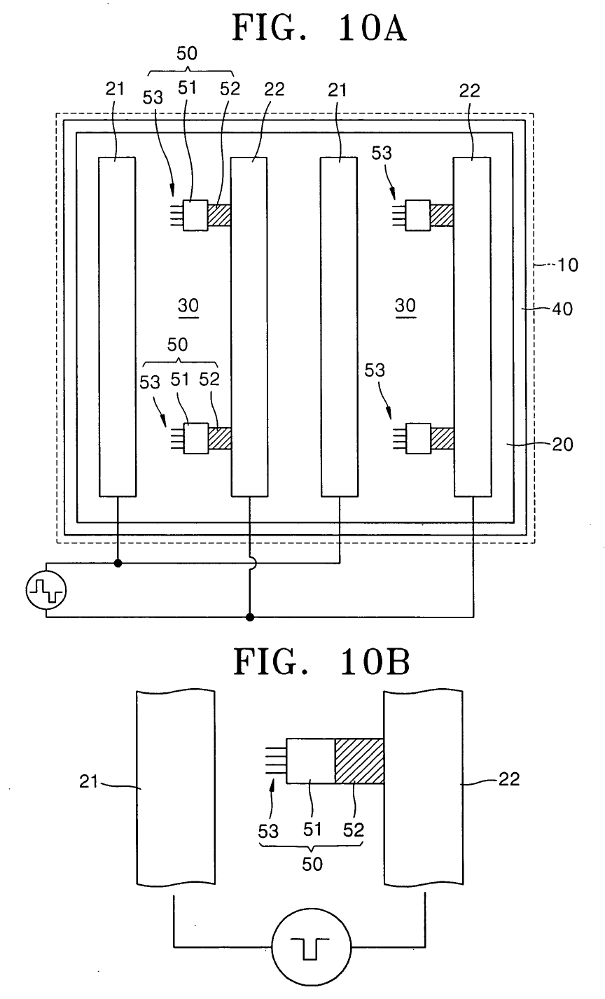

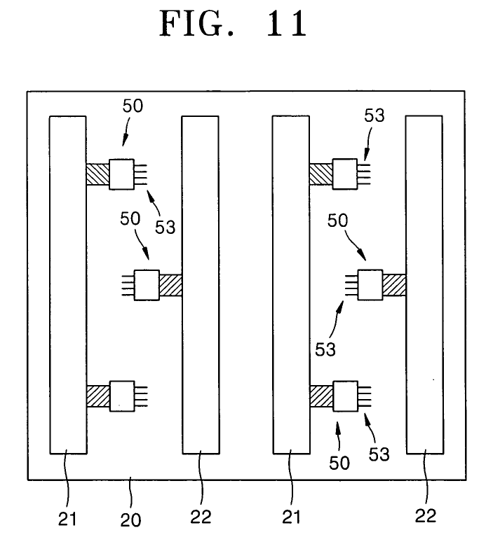

Referring to FIG. 10A, a field emission source is applied to a preliminary discharge unit 50, which is the same as shown in FIG. 4. FIG. 10B is an enlarged view illustrating the preliminary discharge unit 50 of FIG. 10A.

Referring to FIGS. 10A and 10B, an upper plate 10 and a lower plate 20 maintain a predetermined distance, and a discharge gas is filled in the space between the upper plate 10 and the lower plate 20. Two couples of first electrodes 21 and second electrodes 22 are arranged on the lower plate 20 in a row.

Walls 40 are formed at the edges of the upper plate 10 and the lower plate 20 while maintaining the predetermined distance between the upper plate 10 and the lower plate 20 to form a discharge space 30 in which the discharge gas is filled. Fluorescent layers are formed on the inner surfaces or at one side of the upper plate 10 and the lower plate 20.

Preliminary discharge units 50, which are the characteristic of the present invention, are formed on the second electrodes 22. The preliminary discharge unit 50 includes a preliminary discharge terminal 51, which maintains a narrower gap than a main discharge gap between the first electrode 51 and the second electrode 22, a high resistance unit 52 arranged between the preliminary discharge terminal 51 and the second electrode 22, and a field emission source 53 formed on the preliminary discharge terminal 51.

The high resistance unit 52 and the preliminary discharge terminal 51 may be integrally formed, and the high resistance unit 52 may act as a preliminary discharge terminal without using the preliminary discharge terminal 51. The field emission source 53 may be formed of a micro-tip or a carbon nanotube, as described above, or any other field emission material.

The field emission source 53 shown in FIGS. 10A and 10B can be applied to the lamps shown in FIGS. 7 through 9.

FIG. 11 is a plan view of a lamp formed by applying field emission sources to the lamp shown in FIG. 7.

Referring to FIG. 11, field emission sources 53 described with reference to FIGS. 10A and 10B are applied to preliminary discharge units 50 of first electrodes 21 and second electrodes 22. Here, the field emission sources 53 are formed on the preliminary discharge units 50 of the first electrodes 21 and the second electrodes 22; however, the field emission sources 53 may be formed for any one of the first electrodes 21 and the second electrodes 22.

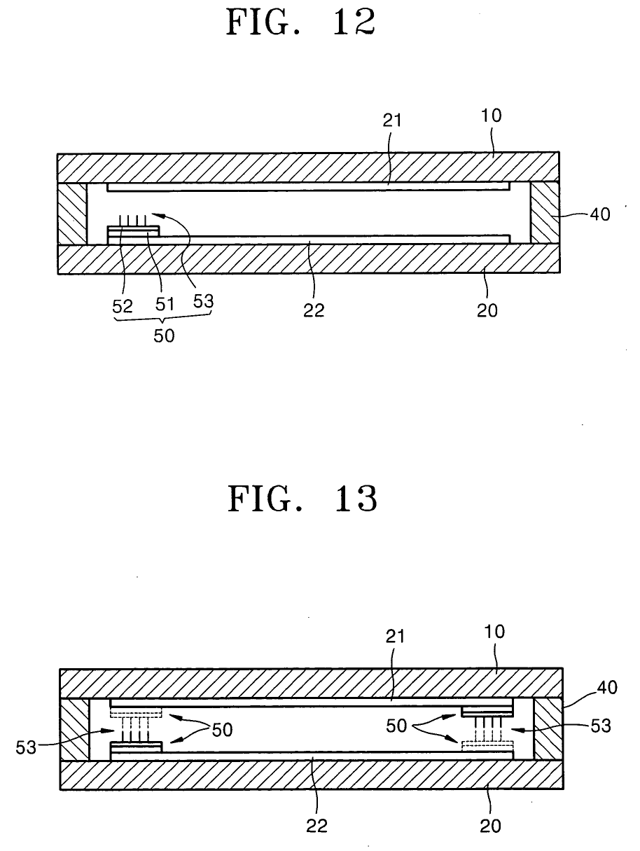

FIGS. 12 and 13 are sectional views illustrating lamps to which field emission sources are applied to the lamps shown in FIGS. 8 and 9, respectively.

Referring to FIG. 12, a front plate 10 and a rear plate 20 are formed with walls 40 therebetween, and a first electrode 21 and a second electrode 22 are formed on the front plate 10 and the rear plate 20, respectively. A high resistance unit 52 having a predetermined height is formed at one side of the second electrode 22 on the rear plate 20, and a preliminary discharge terminal 51 is formed on the high resistance unit 52. A field emission source 53 is formed on the surface of the preliminary discharge terminal 51. Accordingly, the high resistance unit 52, the preliminary discharge terminal 51, and the field emission source 53 are included in a preliminary discharge unit 50.

Referring to FIG. 13, a front plate 10 and a rear plate 20 are formed with walls 40 therebetween, and a first electrode 21 and a second electrode 22 are formed on the front plate 10 and the rear plate 20, respectively. Preliminary discharge units 50 are formed at both sides of the first electrode 21 and the second electrode 22, which are formed on the inner surfaces of the front plate 10 and the rear plate 20, to face each other. Field emission sources 53 are formed on the surfaces of the preliminary discharge units 50. Dotted portions in FIG. 13 denote the preliminary discharge units 50, which may be removed, and it is known that the design may be varied.

A preliminary discharge is induced even at a low voltage due to the emission of electrons from field emission sources 53, by adding the field emission sources 53 to preliminary discharge units 50. Accordingly, a lamp can operate at a low driving voltage. In addition, a material for reducing a work function, for example, MgO may be coated on the surfaces of the field emission sources 53.

The driving voltage of the lamp is reduced by using the preliminary discharge unit having the high resistance unit, more specifically, the field emission sources.

The preliminary discharge unit having the high resistance unit reduces the driving voltage, and the preliminary discharge unit having the high resistance unit and the field emission sources reduces the driving voltage and improves a discharge efficiency.

The preliminary discharge unit may be applied to any type of lamps, for example, AC pulse driving type and DC pulse driving type. However, additional elements corresponding to the types of the lamps should be selectively applied to according to the type of the lamp.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A plasma lamp comprising:
a container filled with a discharge gas;
a main discharge electrode unit including a first electrode and a second electrode, which are located in the container and define a main discharge region of a first gap that generates a main discharge; and
a preliminary discharge electrode unit having a high resistance unit and arranged on at least one of the first electrode and the second electrode, and located adjacent to the main discharge region to define a preliminary discharge region of a second gap, which is smaller than the first gap.

2. The plasma lamp of claim 1, wherein a dielectric layer is covered on at least one of the first electrode and the second electrode.

3. The plasma lamp of claim 1, wherein the first electrode and the second electrode are arranged in a row.

4. The plasma lamp of claim 1, wherein a plurality of electrode couples including the first electrode and the second electrode, which is corresponding to the first electrode, are arranged.

5. The plasma lamp of claim 1, wherein the container includes a front plate and a rear plate, which are separated by a predetermined distance.

6. The plasma lamp of claim 5, wherein the first electrode and the second electrode are formed any one of the inner surfaces of the front plate and the second plate.

7. The plasma lamp of claim 5, wherein the first electrode and the second electrode are formed on the inner surfaces of the front plate and the second plate, respectively.

8. A plasma lamp comprising:
a container filled with a discharge gas;
a main discharge electrode unit including a first electrode and a second electrode, which are located in the container and define a main discharge region of a first gap that generates a main discharge;
a preliminary discharge electrode unit having a high resistance unit and arranged on at least one of the first electrode and the second electrode, and located adjacent to the main discharge region to define a preliminary discharge region of a second gap, which is smaller than the first gap; and
a field emission unit arranged at the end portion of the preliminary discharge electrode unit.

9. The plasma lamp of claim 8, wherein the field emission unit is formed of any one of a micro-tip and a carbon nanotube.

10. The plasma lamp of claim 8, wherein a dielectric layer is covered on at least one of the first electrode and the second electrode.

11. The plasma lamp of claim 8, wherein the first electrode and the second electrode are arranged in a row.

12. The plasma lamp of claim 8, wherein a plurality of electrode couples including the first electrode and the second electrode, which is corresponding to the first electrode, are arranged.

13. The plasma lamp of claim 8, wherein the container includes a front plate and a rear plate, which are separated by a predetermined distance.

14. The plasma lamp of claim 13, wherein the first electrode and the second electrode are formed any one of the inner surfaces of the front plate and the second plate.

15. The plasma lamp of claim 13, wherein the first electrode and the second electrode are formed on the inner surfaces of the front plate and the second plate, respectively.
